(19) United States
(12) Patent Application Publication
(10) Pub. No.: US 2010/0253679 A1
(43) Pub. Date: Oct. 7, 2010

(54) SYSTEM FOR PSEUDO 3D-INFORMATION DISPLAY ON A TWO-DIMENSIONAL DISPLAY

(76) Inventor: Georgy R. VYAKHIREV, Salekhard (RU)

Correspondence Address: HOUSTON ELISEEVA, 420 BEDFORD ST, SUITE 155, LEXINGTON, MA, 02420, US

(21) Appl. No.: 12/730,522

(22) Filed: Mar. 24, 2010

Related U.S. Application Data
(63) Continuation of application No. PCT/RU2008/000585, filed on Sep. 4, 2008.

(30) Foreign Application Priority Data
Sep. 28, 2007 (RU) 2007135972

(51) Int. Cl. G06T 15/20

(52) U.S. Cl. 345/419

(57) ABSTRACT

The inventive system for pseudo 3d-information display on a two-dimensional display comprises a device for displaying information on a two-dimensional plane, in the form of a personal computer display or a TV screen with a device for forming an image, which is positioned in front of a user in such a way that the user is able to perceive said image on the display or screen by his organs of sight, and at least one sensor for tracking the movement of the user's head or eyes in relation to the display or screen. The computer hardware or the device for forming an image in the TV-set is provided with a function for correcting the image according to the position thereof with respect to the user located in front of the device, which displays information on a two-dimensional plane, by proportionally enlarging the image objects when the distance is decreased or proportionally reducing the image objects untill the detailes thereof are lost when the distance is increased, and with a function for correcting the image according to the angular displacement of the user in relation to the device, which displays information on a two-dimensional plane, by displacing the image and/or the relative position of the objects constituting a virtual 3D space, i.e the interface of the user.

### RELATED APPLICATIONS

This application is a Continuation of International Application No. PCT/RU2008/000585 filed on Sep. 4, 2008, which claims priority to Russian Patent Application No. 2007135972 filed on Sep. 28, 2007, both of which are incorporated herein by reference in their entirety.

### FIELD OF THE INVENTION

The invention relates to computerized means for providing information on a two-dimensional display and can relate to means for display of information in all areas of human activity, for example, in systems for industrial modeling of objects, in operating systems for personal computers, in computer programs and games, in medical equipment, in industrial equipment, in television, in cell phones and mobile communicators, i.e., everywhere there is a user and a projection screen or electronic display to which information is output for the given user.

### BACKGROUND OF THE INVENTION

A system is known in the prior art for immersion of the user in a virtual reality, which relates to computer games, space, sports, and military training simulators (RU2120654 [sic, should be RU2120664?], G09B9/00, A63G21/00 [sic, should be A63G31/00?], published 20 Oct. 1998) and which includes a closed capsule in the form of a sphere, delimiting real space and placed on supports with the capability of rotation about its center. In the sphere, there is at least one hatch, equipped with a cover, for entrance and exit of the user. The system includes a means for the formation of a virtual space, placed on the user, which is a portable computer.

The means for displaying the virtual space to the user is a helmet, worn on the user's head, where the display for displaying the virtual or real three-dimensional space to the user is located in the helmet, in front of the user's eyes. The system includes a unit for transformation of the virtual space according to the real physical movements of the user, executed by the user within the capsule, which is designed to run an additional program for transformation of the virtual space. The user holds a joystick in his or her hand to interactively manipulate objects in the virtual space displayed to him or her on the display screen. The system includes a means for determining the magnitude and direction of the user's movement relative to the capsule, connected to the unit for transformation of the virtual space. The means for determining the magnitude and direction of movement of the user relative to the capsule includes a large number of sensors, placed on the user and determining the position of parts of the user's body.

This design is taken as the prior-art prototype for the claimed system.

The prior-art system for immersion of the user in a virtual reality operates as follows. A closed capsule, delimiting real space, is formed. The capsule is placed on supports with the capability of rotation about its center with three degrees of freedom. The user is placed in the capsule and can freely move over the inside surface of the capsule.

By means of a computer, a virtual space is formed in which objects and subjects, such as walls of houses, trees, machines, animals, people, clouds, etc., appear and move in specified and random ways. The virtual space formed is displayed on the screen of the display, and the user sees a three-dimensional image of the virtual world. The virtual space is continuously transformed according to a built-in program. Since the user does not see the edges of the screen due to the helmet design, he or she experiences the illusion of total presence in the virtual three-dimensional space. By taking real steps, the user approaches objects and subjects in virtual space. By taking a step, the user rotates the capsule underneath him with his foot, i.e., rotates it in the direction opposite to his motion. Such motion of the capsule is possible because it is mounted on movable wheeled supports, which easily and freely repeat rotations of the capsule in any direction.

A disadvantage of this system includes the complex design and the inconvenience of using it.

The aim of the present invention is to solve the technical problem of formation of pseudo-three-dimensionality of the image, which depends on how far away the user is from the monitor screen or if he is moving away from the monitor screen.

### SUMMARY OF THE INVENTION

The technical result attainable in this case includes simplification of the hardware system for realization of the three-dimensionality effect for the image and/or the virtual reality.

The indicated technical result is achieved by the fact that the system for pseudo-three-dimensional display of information on a two-dimensional display is characterized in that it includes a device displaying information in a two-dimensional plane, in the form of a display of a personal computer or a television receiver screen with a device for forming an image located in front of the user for the latter to perceive the image on the display or screen using his organs of sight, at least one sensor for tracking the movement of the user's head or eyes relative to the display or screen, where the hardware of the personal computer or device for forming the image in a television receiver is implemented with a function for correcting the image depending on the position of the user when he is situated in front of the device displaying information in a two-dimensional plane, by varying the proportions and position of objects in the image as this distance decreases or as this distance increases, and with a function for correcting the image depending on the angular displacement of the user relative to the device displaying information in a two-dimensional plane.

The indicated features for each embodiment are essential and interrelated, forming a well-established set of essential features sufficient to achieve the required technical result.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

In FIG. 1: block diagram of a system for pseudo-three-dimensional display of information on a two-dimensional display;

FIG. 2: demonstration of the image as the distance between the screen and the user decreases;

FIG. 3: demonstration of the image for an angular displacement of the user relative to the screen.

### DETAILED DESCRIPTION OF THE PREFERRED EMBODIMENTS

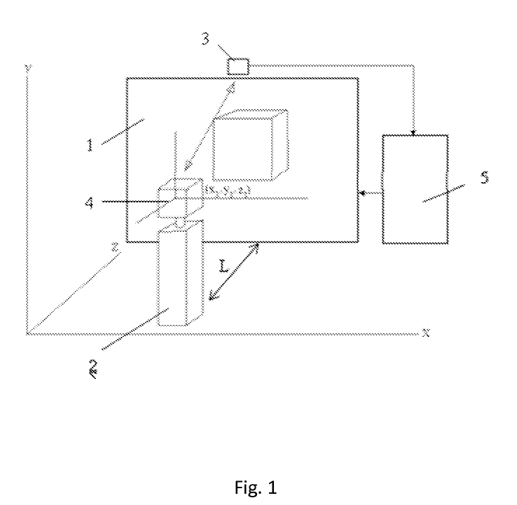

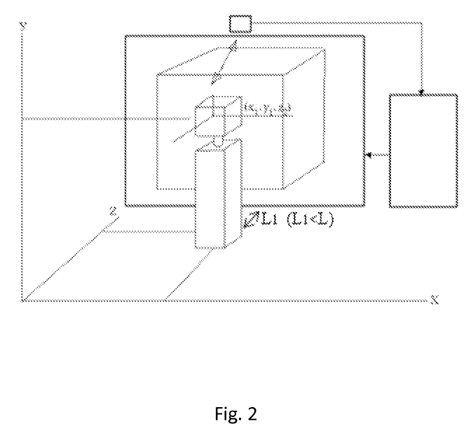

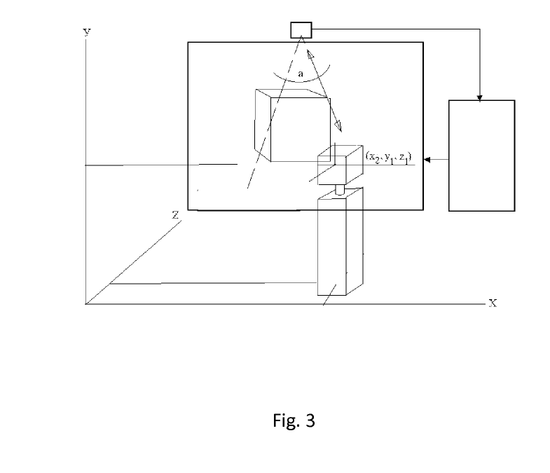

Within the scope of the present invention, we consider a system (FIG. 1) for pseudo-three-dimensional display of information on a two-dimensional display which includes device 1 displaying information in a two-dimensional plane, in the form of the display of a personal computer or a television receiver screen with a device for forming an image located in front of user 2, for the latter to perceive the image on the display or screen using his organs of sight, at least one sensor 3 for tracking the movement of the user's head 4 or eyes relative to the display or screen, where the hardware of personal computer 5 or device for forming the image in a television receiver is implemented with a function for correcting the image depending on the distance L to the user when he is situated in front of the device displaying information in a two-dimensional plane, by proportional magnification of the objects in the image (FIG. 2) as this distance decreases or proportional de-magnification of objects in the image as this distance increases, and with a function for correcting the image depending on the angular displacement “a” of the user relative to the device displaying information in a two-dimensional plane, by means of displacement of the image laterally away from the direction of displacement of the user or rotation of the objects in the image (FIG. 3) laterally away from the direction of displacement of the user.

The system for pseudo-three-dimensional display of information on a two-dimensional display (FIG. 1) is a system for display of information with feedback (interactive) [and] can consist of the following components:

1) At least one User (for example, a User sitting in front of the display of a personal computer or the screen of a television receiver) for whom some device is used to form an image he can perceive using his organs of sight. In the general case, optionally any animate or inanimate object which has organs of site or visual sensors can act as the user. An example is an autonomous robotic system having artificial intelligence and image sensors (analogous in function to organs of sight), which are one of the channels for collecting information about its surroundings.

2) At least one device for displaying information, at least showing an image in a two-dimensional plane (for example, the monitor of a personal computer or a television screen or a cell phone display), including software or hardware altering or correcting the image on the screen and/or elements of the program interface, the functionality or functions of means for input/output of information and other characteristics of the device, according to some algorithm, at least one of the input conditions for which is the position of the user in space relative to the display, calculated or determined from the sensor signal;

3) At least one sensor tracking the user, for example a video camera, determining the relative position of the User's organs of sight and/or his head relative to the screen of the device displaying the information to the User. The most favorable situation is when the position is determined for only both eyes or one eye (organ of sight) of the user in space. In the case when a webcam is used as the sensor, the position of the User can be determined using a pattern recognition program. In order to simplify the problem, some element can be attached to the user which can be easily identified on the image and accordingly can isolate the signal indirectly indicating the position of the user's eyes. A possible situation is when the approximate position of the user relative to the screen of the device is determined using sensors determining the position of the device itself in space by some method (position sensors) (applicable, for example, for small devices such as cell phones). In this case, the position of the user can be assumed to be known a priori, within a certain degree of accuracy, both in time and space. For example, from the responses of the user on the keys of the device, the time and position of the device in space can be detected and it can be assumed in this case that at that instant, the User was located perpendicular to the plane of the display of the device, at a distance from it that is comfortable for viewing the information. Such a sensor can be a gyroscope or a sensor detecting the position of the device in space relative to the lines of the Earth's magnetic field or the Earth's gravitational force.

If a system is constructed consisting of the User plus the display at which he is looking plus the image, which varies according to the algorithm built into the device, in which at least one signal (the information) coming from the feedback sensor is processed, containing information which can be used to determine the position of the user's head (eyes) in space, then the image for the given user can be “brought to life” and made pseudo-three-dimensional provided that the User moves his head or accordingly his organs of sight (eyes) in some way.

Instead of creating a three-dimensional virtual reality or simultaneously with the latter, an interactive user interface can be simply created which alters the image output for the user and/or changes the elements of the interface, responding to movement of the user in space relative to the screen of the device. Using the invention, for example, output of information to the monitor of a personal computer and input of data through the keyboard can be blocked when the program detects that the user has moved away from the monitor by a significant distance from the display of the personal computer.

For technical realization of the device design, in which this principle for displaying information will be built in, we need to make use of widely used principles for the formation of a three-dimensional image of subjects in different types of projections. In particular, from a school drafting course we know that in order to display three-dimensional subjects on a plane, several types of projection of three-dimensional figures onto the plane of the drawing sheet are used. For example, this can be done in axonometric projection. As in drafting, we can project three-dimensional figures created in three-dimensional virtual space onto the plane of a two-dimensional screen of a display or projector or similar devices for output of information. This has already found widespread practical application in computer-assisted modeling of 3D objects (CAD), in computer games, medicine, machines, in animation of images for movies and television, etc. In movies, television, and video filming, projection of a multidimensional space onto a plane (i.e., onto a two-dimensional image) occurs in a video recording device on the plane of a semiconductor sensor or motion picture film. Due to the use of projection, the human brain partially restores the three-dimensionality of the image observed on the plane. But in this case, the depth of the image is lost and we cannot determine the distance to the subjects imaged by the method of projection onto a plane in virtual scenes, since the proportions of the subjects are always changing and have nonlinear dimensions, and the dimensions of the original subjects are known only approximately. A clue to a way out of this situation can be found in nature.

Some animals find themselves in a similar situation. Some birds cannot observe a true three-dimensional image (using two eyes simultaneously to look at objects) due to the characteristic feature of the separation of their eyes on opposite sides of their heads. Accordingly, the picture they observe of their surroundings is not complete and is flat, projected onto the retina of each eye individually. They cannot superimpose both images and obtain a stereoscopic image, as humans do. But they successfully determine the distance to objects by constantly bobbing their heads. Subjects close to them in the observed scene in the space surrounding them are shifted relative to subjects that are further away. Thus birds see a pseudo-three-dimensional image and accordingly can estimate the distance to the subjects they observe even with one eye. I propose to incorporate a similar principle into the formation of an image by information display devices. This method can “bring static images to life” (give them pseudo-three-dimensionality). They can acquire three-dimensionality, and this will be done so naturally that the User will perceive “depth” of the image, as if the picture he observes were not on the monitor but rather in the surrounding space.

To do this, it is necessary to use the widely known principle of relativity. Let us assume that a bird is at the display of the device and is looking at the screen with one eye. If the image at which the bird is looking is altered in coordination with the bobbing of the bird's head, such as, for example, by bobbing the video camera while filming the source of the image, then the bird sees almost the same thing as it observes in nature. The device for displaying information in a plane must be made so that bobbing of a human head would be perceived by the information display device. The virtual three-dimensional scene displayed on the two-dimensional plane of the display should be constructed at each instant of time in coordination with the movements of the User, so that both human eyes perceive the picture as if we were viewing the three-dimensional virtual scene constructed at the display, taking into account its projection onto the plane of the screen of the display. Subjects close to the user in the scene he observes in virtual space should be shifted as his head bobs relative to the subjects that are further away, by a certain distance.

But the invention does not just relate to 3D objects in a virtual space created using computer systems. For example, the three-dimensional (3D) interface of the operating system already developed by Microsoft and used in some versions of Windows Vista can be tweaked so that the “Switch Between Windows” mode would respond to movement of the User and/or his organs of sight relative to the display. This can be done so that as the User approaches the screen of the display, the “windows” of currently open programs (displayed in projection, as though suspended in different layers within three-dimensional space at some distance from each other) would approach the user the same way, in this case being magnified with enhanced detail of the image. And conversely, as the User moves away from the display, they would be de-magnified, “losing” their detail. If the User not only approaches or moves away but also laterally tilts his head away from the center of the display relative to the plane parallel to the plane of the display, then the images of the application windows shown in “Switching Between Windows” mode can rotate relative to the vertical axis of the three-dimensional projection.

An image of the “Desktop”, the so-called “Desktop Wallpaper” of the Windows operating system (or, for example, mobile devices such as communicators and cell phones) can be created so that the image looks three-dimensional to the user. We can make any elements of the program and operating system interface three-dimensional. In this case, there is no significant utilization of system resources, since dynamic changes in the 3D scene will be small because the User executes his movements with low frequency and amplitude. Furthermore, the complexity of the image output to the display can be varied and limited, with the aim of minimizing demands on the system resources of the device.

With regard to animated scenes created on a computer, movie and television scenes that can be reproduced on personal devices, this invention can help overcome problems facing developers of stereoscopic 3D displays concerning processing and output of true three-dimensional images. This invention will make it possible to output a pseudo-three-dimensional image to currently existing 2D (two-dimensional) displays, which do not have capabilities for output of true stereoscopic images. It will be important to prepare the corresponding video material by encoding the stereoscopic video image in such a way that during its decoding, the image can be corrected as the scene changes for viewing by the User, in this way creating the effect of viewing a three-dimensional image.

With regard to computer games, where events dynamically unfold from a first-person perspective in the virtual three-dimensional scene, scene dynamics already exist. Correction of a three-dimensional scene, by working out the movements of the User relative to the display, will be practically unnoticed by the user on the background of a rapid change in subject. But in static scenes, quite the reverse happens: it will be very useful to have the capability of tilting or turning the head briefly and to peer out, for example, from concealment or an obstacle.

With regard to tomography systems (in medicine), automatic projection systems of any 3D subjects or objects (CAD, CAM), computer animation, scenes in the movie industry, etc., i.e., everywhere that objects are projected in 3D modeling systems, this invention can be used to improve viewing of the images. Objects can be examined a little off to the side without using any manipulators. Simply put, the User will just have to tilt, turn, or move his organs of sight relative to the subject to be examined on the 2D display, as we would do when examining a real subject standing in front of us at a certain distance from us.

The invention can be used in video phone technology (video conferences), movies, and television. For this purpose, we need to encode the stereoscopic image at the signal source obtained from two video cameras in such a way that, besides the difference information between scenes of successively encoded frames (this means compression standards like MPEG), the difference between images from cameras located at a distance from each other would also be encoded (the cameras are separated by a certain distance, in analogy with the human organs of sight, to obtain a stereoscopic image). Thus the volume of encoded information should increase only slightly. On the receiver end, the information obtained from the cameras is decoded and, in user-tracking mode, is reproduced by creating the illusion of three-dimensionality of the image on a 2D display according to the principle described above.

The differences between the invention and the prior-art prototype include the following:

it is distinguished by the fact that at least one position sensor is used rather than several;

it is distinguished by the fact that the User is not placed in an isolated environment (a sphere);

it is distinguished by the fact that the sensors do not determine the degree of interaction between the human and the environment artificially constructed for him in the form of a sphere and joysticks, but rather the relative position between the User and the screen and/or the information display device itself is calculated. The sensor can not interact physically with the User, and can calculate the position of the User and/or his organs of sight relative to the screen of the device from indirect signs;

it is distinguished by the fact that the three-dimensional image effect of virtual reality is created not only in a virtual 3D helmet (special device) or on a display creating the effect of viewing a three-dimensional image (multidimensional monitor-3D), but also, for example, on a display that displays the image in one plane (two-dimensional monitor-2D). The image on a two-dimensional display (for example, the monitor of a personal computer) can be “brought to life” in this case by realizing the characteristic features of the interactive interface between the user and the device. For example, on a two-dimensional display, an image can also be created for the User which simulates a three-dimensional image (pseudo-three-dimensional dynamic scene). By laterally tilting his head relative to the center of the screen (parallel to the plane of the screen), the User can, by his own dynamic movement, observe three-dimensionality of the scene imaged on the display and examine the subjects imaged on the display as though off to the side. In this case, the effect of observing a three-dimensional scene on a two-dimensional monitor is created, i.e., the subjects are seen as three-dimensional and/or the scene of the image has “depth.” The subjects which should be identified by the User as close to him in the virtual scene will, as the user moves, be shifted along the display in coordination with the movements of the user much more than the subjects who should be identified by the user as located further away in the virtual scene. This will create the three-dimensionality effect for the scene observed by the User on the two-dimensional display. As the head and/or organs of sight of the User approach or move away from the plane of the monitor, the same effect of observing a three-dimensional image on a two-dimensional display also can be observed if the proportions of the subjects, their shift along the display, and their size will change in coordination with the movements of the User relative to the display to which the image observed by the User is output. This all depends on the software and the desires of the user;

it is distinguished by the fact that only already existing information display devices are used to create an interactive system. As needed, they are supplemented by inexpensive sensors and tweaked software, and possibly by tweaked hardware;

it is distinguished by the fact that the software will use minimum technical resources to realize the three-dimensionality effect for the image and/or the virtual reality and/or the characteristic features of the interactive interface. The current state of the art makes it possible to realize the invention even on the screen of mobile devices such as cell phones and handheld computers. This effect can also be used in television. For realization, an appropriately encoded image must be transmitted which is insignificantly increased in size and which can be packed into existing communication channels;

it is distinguished by the fact that, based on this system, it is not necessary to construct a virtual reality simulating three-dimensionality of a virtual scene on a 2D display. It can be realized just by a user interface matching the position of the user on the screen or dynamically varying depending on the position of the user in space. That is, we can create an interface interactively varying according to the movements of the user in space relative to the display, i.e., a tracking program interface matching or responding to movements and controlling actions of the user.

### INDUSTRIAL APPLICABILITY

The present invention is applicable industrially, and can be realized using modern means for construction of electronics technology and the corresponding software.

While this invention has been particularly shown and described with references to preferred embodiments thereof, it will be understood by those skilled in the art that various changes in form and details may be made therein without departing from the scope of the invention encompassed by the appended claims.

What is claimed is:

1. System for pseudo-three-dimensional display of information on a two-dimensional display, characterized in that it includes a device displaying information in a two-dimensional plane, in the form of the display of a personal computer or a television receiver screen for which the image is formed by a digital device for forming an image located in front of the user, for the latter to perceive the image on the display or screen using his or her organs of sight, at least one sensor for tracking the movement of the user's head or eyes relative to the display or screen, where the hardware of the device of the personal computer type or device for forming the image in a television receiver is implemented with a function for correcting the image depending on the position of the plane of the display in space relative to the user when he or she is situated in front of the device displaying information in a two-dimensional plane, by proportional variation of the relative positions and/or proportions of objects in the image as the distance decreases or as the distance increases, and with a function for correcting the image depending on the angular displacement of the user relative to the device displaying information in a two-dimensional plane.
